(19) United States
(12) Patent Application Publication
(10) Pub. No.: US 2004/0149768 A1
(43) Pub. Date: Aug. 5, 2004

(54) Method and apparatus for selling a baby bottle

(76) Inventors: Kimberly Scoville, Provo, UT (US); Kyle Bateman, Provo, UT (US); Randall B. Bateman, Sandy, UT (US); Regan Scoville, Provo, UT (US); Brett Peterson, Bountiful, UT (US)

Correspondence Address: RANDALL B. BATEMAN, BATEMAN IP LAW GROUP, 4 TRIAD CENTER, SUITE 825, PO BOX 1319, SALT LAKE CITY, UT, 84110, US

(21) Appl. No.: 10/651,641

(22) Filed: Aug. 28, 2003

Related U.S. Application Data
(60) Provisional application No. 60/407,546, filed on Aug. 30, 2002.

(51) Int. Cl. G07F 11/72

(52) U.S. Cl. 221/135

(57) ABSTRACT

A bottle and method for dispensing infant formula includes a method for heating a bottle with infant formula (or other liquid) therein and selling the heated bottle.

### RELATED APPLICATIONS

The present application claims the benefit of U.S. Provisional Application No. 60/407,546, filed Aug. 30, 2002.

### BACKGROUND OF THE INVENTION

1. Field of the Invention

The present invention relates to a method for dispensing bottles for young infants. More particularly, the present invention relates to selling infant formula, milk, and the like in a ready to drink or ready to mix state, was well as bottles adapted for that purpose.

2. State of the Art

Each year tens of millions of children are born in the United States and other developed countries. While many of these children are breast fed, many others are given infant formula as their primary source of nutrition. While infant formula is extremely convenient in most situations, times arise in which a person lacks the ability to provide an acceptable bottle to an infant. For example, it is not uncommon when a person is running errands for an extended period of time to run out of formula for the infant. Additionally, it is difficult to keep an infants bottle warm for a prolonged period of time. While car warmers are available for some bottle configurations, they are often inconvenient to use and may result in inconsistent warming of the bottle. Furthermore, the bottle may tip over in the car, thereby staining the interior of the automobile or clothing of the occupants.

Additionally, if a person attempts to mix infant formula, etc. inside a car, there is a risk that the contents of the bottle will spill. The infant formula, which is milk based, often has a generally unpleasant aroma and can quickly sour leaving the car with a noticeable odor. Several brands of formula also stain many types of clothing.

Another problem with mixing bottles while one is out is the ability to keep the bottle substantially sterile. Most parents prefer to have a bottle substantially sterile when it is provided to their infant. However, after being away from home for several hours it is often difficult to find a restroom to wash ones hands to ensure that germs are not passed to the infant. Furthermore many bathrooms which are publicly available are not such that one feels comfortable making a bottle in the bathroom or after washing ones hands in the bathroom. Furthermore, many individuals believe that tap water, with its associated chlorine and possible bacteria is not sufficiently clean for a very young infant.

Thus there is a need for the availability to purchase ready made bottles at a convenient location.

### SUMMARY OF THE INVENTION

It is an object of one aspect of the present invention to provide a method for dispensing bottles which is more convenient than that currently available. Additionally, it is an object of one aspect of the present invention to provide bottles which can be more conveniently sold at convenient locations.

The above and other objects of the present invention are achieved through the dispensing of a bottle having a reservoir portion and a nipple portion which are maintained substantially sterile prior to use.

In accordance with on aspect of the invention, a bottle having a reservoir portion and a nipple is sold as a single unit with the nipple being protected so as to maintain substantial sterility up till the moment of vending.

In accordance with another aspect of the present invention, a bottle is sold in a warmed state so that it may be promptly used by an infant without need to locate a heating device after the sale.

In accordance with another aspect of the present invention the bottle is maintained at a dispensing location in a state wherein the bottle is kept between about 80 and 110 degrees Fahrenheit prior to dispensing of the bottle.

In accordance with another aspect of the invention, the reservoir and nipple are dispensed in a substantially sterile state wherein removing a cover over the nipple renders the bottle ready to drink without further handling by the purchaser.

In accordance with yet another aspect of the present invention, the bottle and nipple are configured so as to isolate the contents of the bottle from the nipple until the point of sale so that the purchaser can ensure that no tampering has occurred with the contents of the bottle.

In accordance with another aspect of the invention, a sealing configuration is provided which can also form a cap for preventing spills of the contents of the bottle.

In accordance with another aspect of the invention, a bottle is provided which keeps the various components of an infant beverage separate until an appropriate time for mixing thereof.

In accordance with another aspect of the invention, the bottles may be sold through a vending machine adapted to deliver the bottle at a predetermined temperature.

### BRIEF DESCRIPTION OF THE DRAWINGS

The above and other objects, features, and advantages of the present invention will become apparent from a consideration of the following detailed description in which:

FIG. 1 shows a flow chart demonstrating a method of dispensing infant formula in accordance with the present invention;

FIG. 2 shows a diagram of an alternate method of dispensing of an infant beverage in accordance with the principles of the present invention;

FIG. 3 shows yet another method of dispensing an infant beverage in accordance with the principles of the present invention;

FIG. 4 shows a cross-sectional view of a bottle formed in accordance with one aspect of the present invention;

FIG. 5 shows a cross-sectional view of an alternate configuration of a bottle formed in accordance with the principles of the present invention;

FIG. 6 shows yet another cross-sectional view of a bottle formed in accordance with the present invention;

FIG. 7 shows still another cross-sectional view of the embodiment of a bottle made in accordance with the present invention;

FIG. 8 shows a warming device in accordance with the principles of the present invention for maintaining a bottle at a desired temperature;

FIG. 9 shows yet another device for warming a bottle in accordance with the present invention.

FIG. 10 shows another device suitable for warming a bottle in accordance with the present invention;

FIG. 11 shows a cross-sectional view of another bottle formed in accordance with the principles of the present invention;

FIG. 12 shows a top view of puncture rings as used in the bottle of FIG. 11;

FIG. 13 shows a cross-sectional view of a bottle in accordance with the present invention;

FIGS. 14 and 14a shows views the plunger of the bottle in FIG. 13 in greater detail;

FIG. 15 shows a bottle in accordance with the present invention sealed in a plastic bag and ready for sale to a consumer; and

FIG. 16 shows a side cross-sectional view of a vending machine designed for storing and dispensing bottles.

### DETAILED DESCRIPTION

Reference will now be made to the drawings in which the various elements of the present invention are discussed in a manner to enable one of skill in the art to make and use the invention. It is to be understood that the following description is only exemplary of the principles of the present invention and should not be viewed as limiting the appended claims.

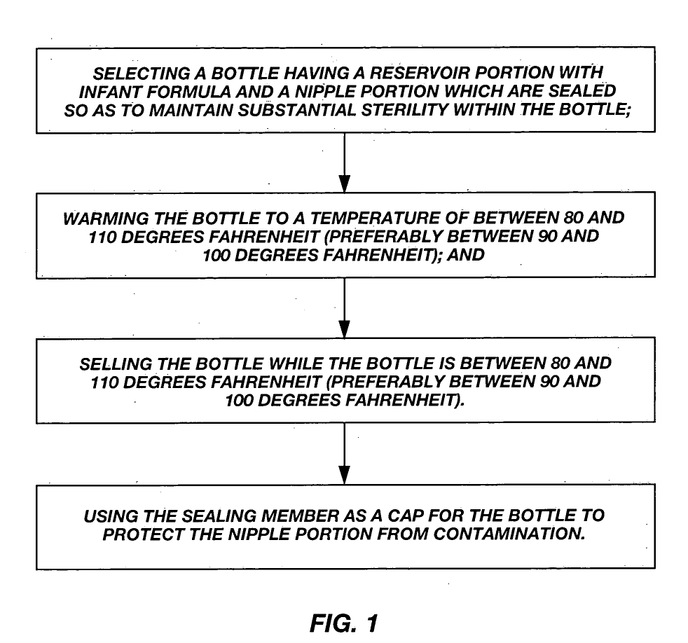

Turning now to FIG. 1 there is shown a diagram of steps of vending infant formula in accordance with one aspect of the principles of the present invention. In accordance with the first step of this aspect of the present invention, a bottle in obtained in a substantially sterile state. By substantially sterile, it is meant that the bottle has been thoroughly cleaned so as to prevent the transmission of harmful bacteria. Those skilled in the art will appreciate that in a preferred application of the present invention the bottle would be sterile. However, the bottle need not be sterile in the context that there are no bacteria to the extent that a surgical instrument would need to sterile.

It is important that the portion of the bottle on which the infants mouth will be placed, namely the nipple, is maintained in such a situation that the purchaser can assure himself or herself that the bottle is clean. Thus, in a typical application of the invention a sealed cap or covering will be placed over the nipple and maintained in such a manner that throughout sale until removed by the purchaser for use by an infant. Furthermore, it is preferred that the sealing member be disposed so that the purchaser of the bottle can be assured that the contents of the bottle have not been tampered with.

The substantially sterile bottle is then warmed to a temperature of between about 80 and 110 degrees Fahrenheit, and more preferably, between 90 and 100 degrees Fahrenheit. Those familiar with infants will appreciate that the ideal temperature for many infants is between about 90 and 96 degrees.

The mechanism for warming the bottle can be any of a variety of methods. For example, a bottle may be immersed in a hot liquid for a pre-determined amount of time to bring the temperature of the infant beverage inside the bottle to a temperature of between about 80 and 110 degrees, and most preferably about 90 to 96 degrees. In such a method, however, it is important that the temperature be carefully monitored to ensure that the infant beverage will not warm to a point that it could burn the infant.

An alternate method for warming the bottle would be to place a bottle in the warming chamber which is set at an appropriate temperature to allow the bottle to remain for a prolonged period of time in the warming chamber so that bottle may simply be withdrawn at the time of sale.

It will also be appreciated in accordance with the principles of the present invention that the infant beverage can be warmed in a mixed state, or in a premixed state so that the liquid in the bottle is warmed and then mixed with some other ingredient of the beverage.

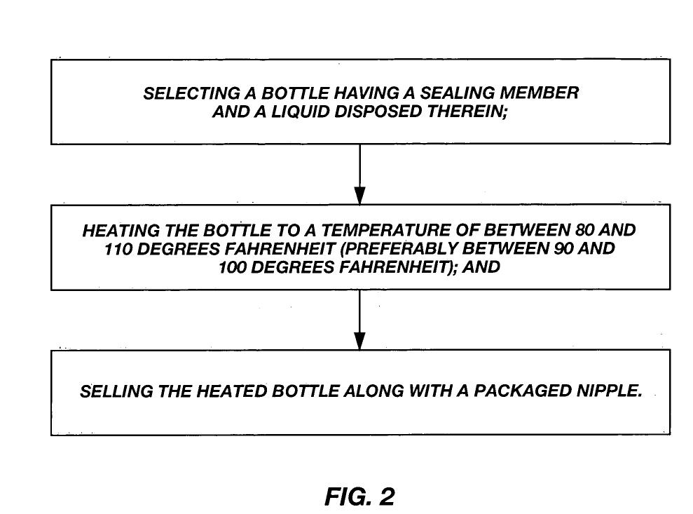

Turning now to FIG. 2 there is shown the steps of an alternate method in accordance with the present invention. In accordance with the alternate embodiment, a sealed bottle is warmed to a pre-determined temperature. The sealed bottle is then sold along with a nipple. The purchaser may then remove the packaging of the nipple to place in on the bottle to allow use by a child. While such a method provides a bottle which is warm, those familiar with the infant formula will understand that it has the disadvantage that the bottle is open thereby risking a potential spill. Additionally, because the bottle is open any contaminants which may be in the atmosphere may enter the bottle when it is assembled.

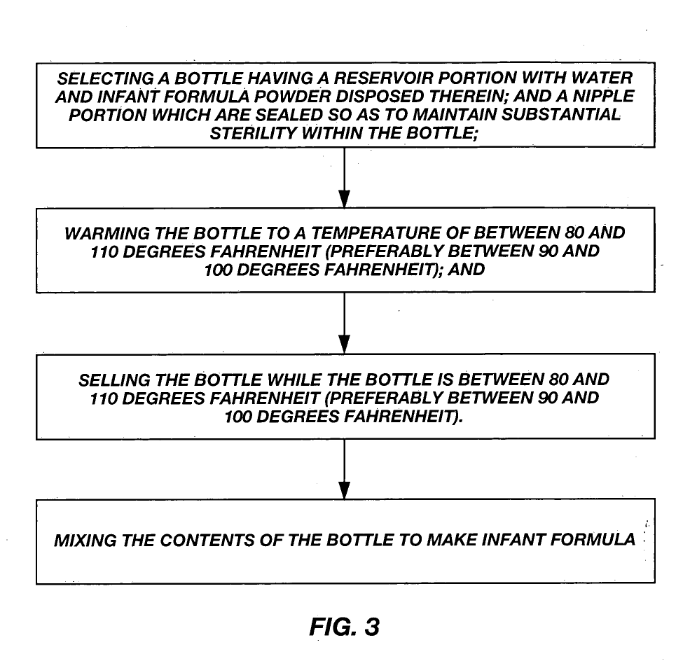

Turning now to FIG. 3 there is shown yet another method for dispensing a bottle. The bottle with a nipple attached is warmed to an appropriate temperature. This may be done either by keeping the bottle in a warmer which maintains the bottle at a desired temperature or by heating the bottle once it is ordered. The bottle is then sold to the user. The user then adjusts the top of the bottle to puncture a seal between the nipple and the contents of the bottle to thereby dispose the contents in communication with the nipple. In such a configuration, the user of the bottle can be assured that the bottle has not been contaminated or tampered with thereby ensuring the safety of the bottles product. (Those skilled in the art will also appreciate that the seal between the nipple and contents of the bottle could be formed from a heat sensitive material which would fail at a predetermined temperature to allow mixing of the contents and/or flow out of the nipple.)

In accordance with an aspect of this method, the contents of the bottle are pre-mixed formula or milk. In an alternate aspect of this embodiment the formula or some other additive, such as rice cereal is maintained separated from a liquid in the bottle such as water. Upon puncturing or otherwise opening the seal the two contents are allowed to mix, thereby creating a formula or a rice cereal mixture, etc.

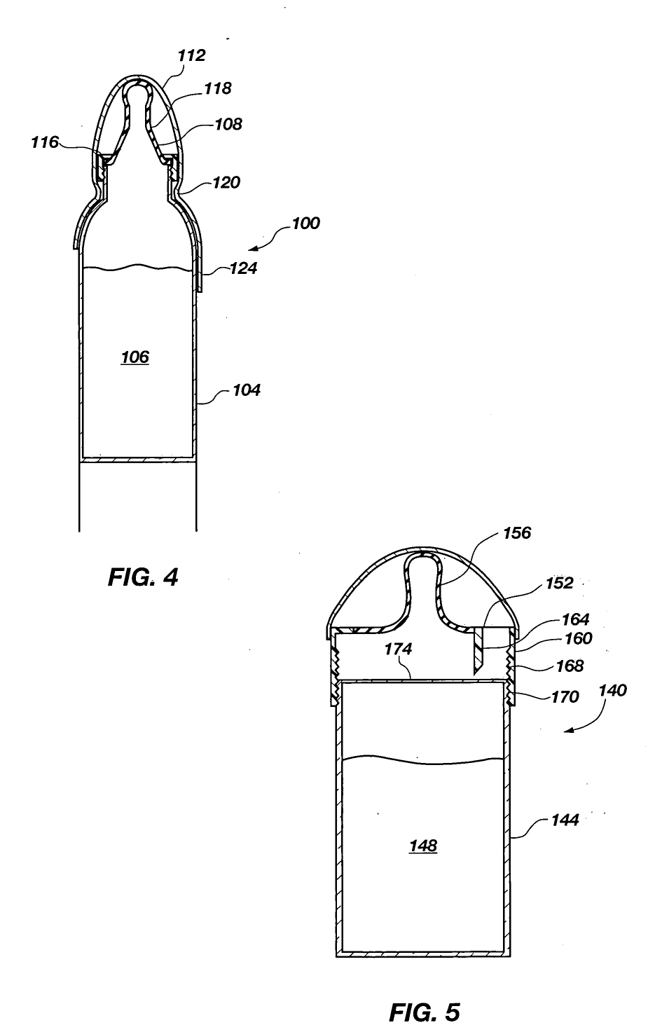

Turning now to FIG. 4 there is shown a cross sectional view of a bottle that can be used in accordance with the present invention. The bottle generally indicated at 100, includes a reservoir portion 104 for holding a liquid 106 (such as infant formula, a juice concentrate, etc.) and a nipple portion 108 for providing access to the contents of the reservoir portion when sucked on by a child.

Also provided is a sealing member 112 which extends over the nipple portion 108 and engages the reservoir portion 104 so as to protect the nipple portion form contamination and to prevent tampering with the contents of the reservoir portion. Due to the presence of the sealing member, it is not important whether the nipple portion 108 is attached by a threaded ring, such as ring 116, or by some attachment mechanism which does not allow the nipple 118 or all of the nipple portion 108 to be removed form the reservoir portion 104. (Those skilled in the art will appreciate that snap-on lids or retainer rings can also be used.)

Upon purchase, the sealing portion can be removed by the user to thereby expose the nipple portion for use by an infant. This is typically done by accessing a perforated or scored portion 120 of the sealing member 112 disposed slightly below the ring portion 116. Because the sealing member 112 has covered the nipple portion 108 and prevented access to the reservoir portion 104, a purchaser of the bottle is assured that the contents of the bottle have not been tampered with since it was packaged. The upper part 112a of the sealing member 112, can then be conveniently used as a cover for the nipple after the perforated or scored portion has been removed. This prevents the bottle from spilling in one's automobile and soiling the interior thereof.

Additionally, a temperature strip 124 may be provided on the bottle 100 so as to enable the purchaser of the bottle to determine that the bottle is in fact the proper temperature and will not burn the infant. The temperature strip 124 can be adhesively attached to the bottle 100, or may be held in place by the sealing member 124.

With the bottle 100 shown in FIG. 3, it is relatively easy to sell a ready to use infant beverage, such as infant formula. The bottle need only be heated to a desired temperature. Because it is sealed, it can be maintained at a desired temperature for a prolonged time—thereby allowing the bottle to be ready when needed. Thus, a restaurant could keep a number of bottles warmed. When requested by a customer, a bottle could be sold to the customer ready to use. This is particularly beneficial for drive-through restaurants or restaurants having a child play area, as it would be a draw to a family having an infant. If the family is in need of a bottle for the infant, it is highly likely that they will order other food at the same time. Additionally, in the evening, a person on their way home may purchase a pre-warmed bottle for an infant so that the infant can fall asleep in the car. This is far more preferable than arriving home with a sleeping infant and then waking the infant to feed him or her so he or she does not wake up in the middle of the night.

Turning now to FIG. 5, there is shown an alternate embodiment of a bottle, generally indicated at 140, formed in accordance with the principles of the present invention. The bottle 140 includes a reservoir portion 144 at least partially filled with a liquid (preferably infant formula) 148.

Attached to the reservoir portion 144 is a nipple portion 152. The nipple portion 152 includes a nipple 156 and an attachment ring 160 for holding the nipple to the reservoir portion 144. As shown in FIG. 5, the nipple portion also includes an opener 164 which extends downwardly and an extended threaded portion 168 on the ring 160. When the ring 160 is rotated on a neck 170 of the reservoir portion 144, the opener 164 is forced down through a seal 174 on the reservoir portion 144, thereby providing access to the liquid 148 in the reservoir portion.

In such a manner, the reservoir portion 144 and the nipple portion 152 can be sold as a single unit, or can be provided as two separate pieces which the user assembles. Because the contents of the reservoir portion 144 are sealed, the purchaser is sure that no tampering has occurred. Additionally, if the reservoir portion is accidentally dropped in the purchaser's car, the contents of the reservoir portion 144 will not spill, as they are sealed until the cap is attached.

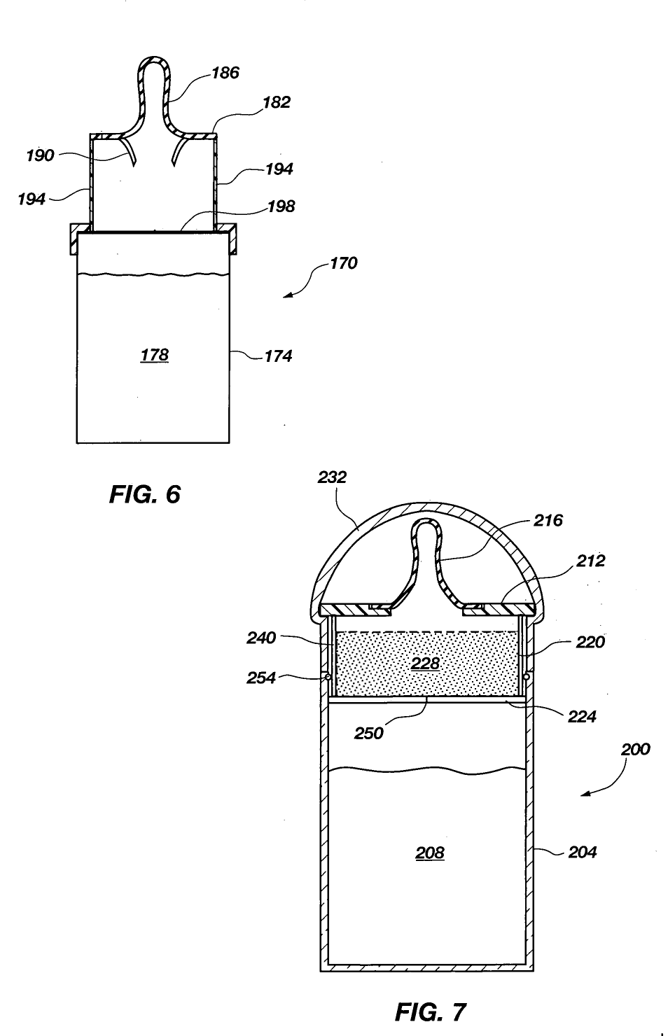

Turning now to FIG. 6, there is shown yet another embodiment of a bottle, generally indicated at 170, formed in accordance with the principles of the present invention. The bottle 170 includes a reservoir portion 174 for holding infant formula 178, and a nipple portion 182.

The nipple portion 182 includes a nipple 186, a piercing element 190 and a collapsible portion 194. When the bottle 170 is sold, the purchaser pushes down on the nipple portion 182 to cause the piercing element 190 to pierce a seal 198 disposed adjacent the top of the reservoir portion 174. Prior to piercing of the seal 198, the purchaser is assured that the contents of the reservoir portion have not been tampered with. Once the seal 198 has been pierced, the infant can readily access the infant formula, etc. 178.

Turning now to FIG. 7, there is shown yet another embodiment of a bottle, generally indicated at 200, made in accordance with the principles of the present invention. The bottle 200 includes a reservoir portion 204 which holds water 208 or some other liquid, and a nipple portion 212 having a nipple 216.

The nipple portion 212 also includes a holding chamber 220 which is separated from the water 208, etc., in the reservoir portion 204 by a seal 224. In use, the holding chamber 220 holds infant formula powder 228 or some other mixture, such as rice cereal, etc. (As used herein, powder is intended to cover formula and cereal mixtures regardless of whether a powder, crystalline, etc.) A cap 232 can also be provided to cover the nipple portion 212 and to maintain the nipple portion in the position shown in FIG. 7.

Once the bottle 200 is purchased, the purchaser removes the cap 232 if such is provided and then presses downwardly on the nipple portion 212. This causes the sidewall 240 which defines the holding chamber 220 to push open the seal 224. Preferably, the seal 224 has one or more scores 250 which facilitate opening of the seal so that the powder 228 or other material in the holding chamber 220 mixes with the water—thereby creating the desired infant beverage.

Keeping the powder 228 or other material separate from the liquid (typically water or milk) allows the purchaser to know that the product is fresh. Additionally, while liquid infant formula is readily available, many parents do not like the brownish tint which several varieties have. By providing powder, and allowing the user to mix the powder with the water, etc., after purchase provides an advantage in the view of some parents.

Providing such a configuration also increases the availability of using a microwave or similar heating device to warm the liquid 208. Most formula providers caution against the use of microwaves because they tend to create heat zones in which the top of the liquid in the bottle is very hot, even if the remainder of the bottle does not feel warm. Heat zones, however, can be quickly eliminated by shaking the bottle. By providing the powder 228 separate, the bottle must be shaken to mix the formula, etc., prior to being given to the child.

Those skilled in the art will appreciate that there are numerous different methods for ensuring that the bottle does not leak. For example, an o-ring 254 can be provided to seal between the reservoir portion 204 and the sidewall 240 of the nipple portion 212. Likewise, a snap on ring or nipple could be used.

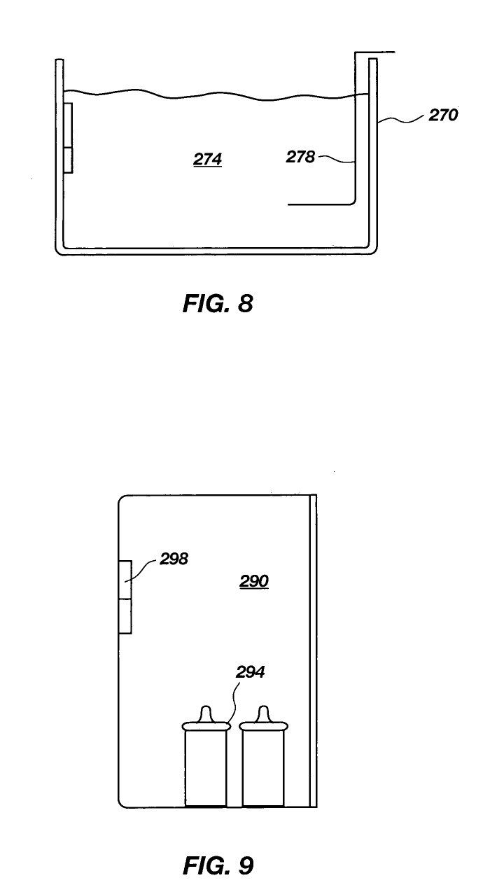

FIG. 8 shows a cross-sectional view of a warming device, generally indicated at 270, made in accordance with the present invention. The warming device 270 includes a trough 274 which is filled with a liquid. Preferably, the liquid is water which is heated to at least 90 degrees and more preferably in excess of 110 degrees Fahrenheit.

Moveably disposed in the trough 274 is a bottle carrier 278 which receives a bottle (not shown in FIG. 8). When a bottle is ordered, a worker at the restaurant, etc., places the bottle in a bottle carrier 278 and presses down. In the minute or two the that a customer waits for his or her order to be filled, the bottle is warmed to a desired temperature range, preferably between about 90 and 100 degrees Fahrenheit. At the end of the period, the bottle is removed from the trough 274 by the bottle carrier 278. This may be done gradually by the carrier as the bottle warms, or may be done quickly once the predetermined time has elapsed. Obviously, it is important that the temperature in the trough be maintained at a known temperature to prevent overheating or under-heating of the bottle.

FIG. 9 shows an alternate mechanism for warming the bottle. Rather than placing the bottle in a hot liquid when ordered by the customer, the mechanism comprises a warming chamber 290 which is between 80 and 110 degrees Fahrenheit. One or more bottles 294 are placed in the chamber several minutes prior to the time when bottle sales typically occur (most likely during the morning commute as people drop the children at school or child care, during lunch hours, and in the evening). The bottles warm up so that they are ready when ordered. Because the bottles have been sterilized, bacteria growth is not a problem.

Once an order is made, the restaurant worker, etc., need only reach in and grab a bottle 294. Because of the temperature, the worker can grab the bottle without any risk of being burned or any risk that the child will be burned. The temperature within the chamber is maintained by a thermometer 298 and associated controls.

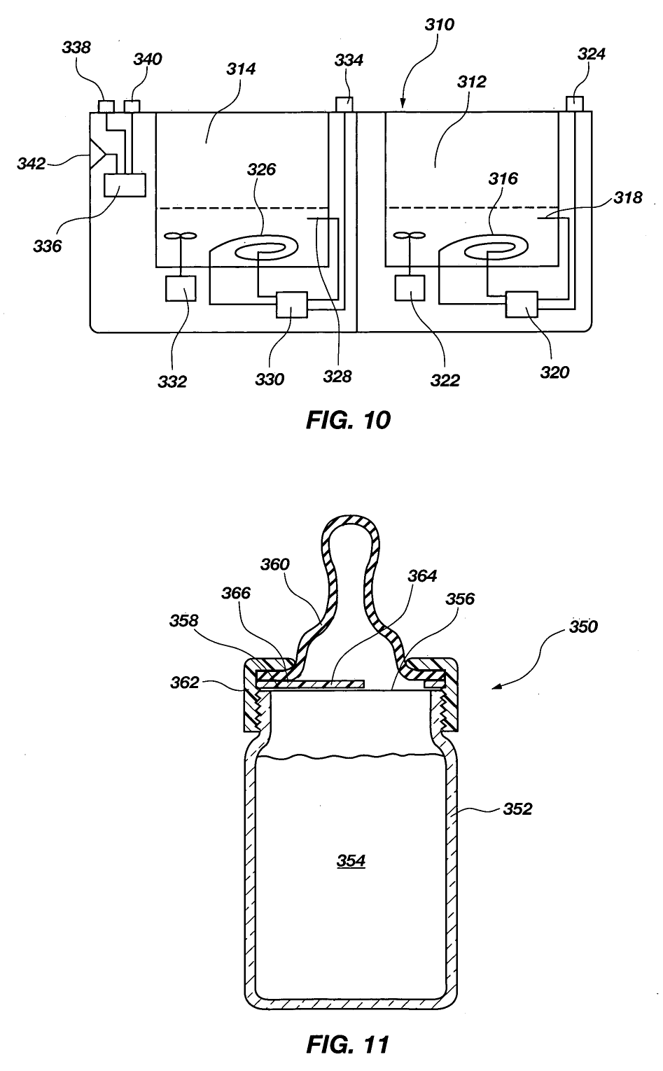

Turning now to FIG. 10, there is shown a diagram of another device suitable for warming bottles in accordance with the present invention. A dual zone water bath, indicated generally at 310, contains two separate heating compartments, 312 and 314, each of which contains water for heating bottles pre-filled with infant formula. In accordance with one object of the present invention, one water bath 312 is maintained between 90 and 96 degrees Fahrenheit. This water bath is used to maintain heated bottles at the desired temperature for feeding an infant. Accordingly, the water bath 312 utilizes a heater 316, a thermocouple 318, a temperature control unit 320, and a water circulation unit 322 to maintain the desired water temperature. The water bath also uses an indicator light 324 to indicate when the water bath is at the proper temperature.

The water bath 314 is maintained at approximately between 120 and 160 degrees Fahrenheit. This water bath 314 is used to quickly bring a bottle up to the desired temperature for feeding an infant. This water bath also uses a heater 326, a thermocouple 328, a temperature control unit 330, and a water circulation unit 332 to maintain the desired water temperature. The water bath also contains an indicator light 334 to indicate when the water bath is at the proper temperature. The quick heating water bath 314 additionally uses a timer 336 to time the bottles being heated so as to ensure that the bottles are heated to the proper temperature. A button 338 is used to start, stop, or reset the timer and a light 340 and speaker 342 indicate visually and audibly when the bottles are properly heated. The heated bottles may then be moved from the heating bath 314 to the temperature maintaining bath 312 to be properly maintained at the desired temperature.

Similar to the dual water bath heater shown in FIG. 10, a dual zone warming oven may be constructed. It would also contain two compartments, one maintained at a temperature between 90 and 96 degrees Fahrenheit and one maintained between 120 and 160 degrees Fahrenheit. Similar elements such as the heater, temperature control, and circulation fan would be used to maintain the temperature. A timer and alarm circuit would also be used to control the heating of the bottles in the hotter oven. Indicator lights would also be used to indicate when the ovens are at the proper temperature and when bottles are done heating.

Referring now to FIG. 11, another bottle in accordance with the present invention is shown generally at 350. The bottle 352 is pre-filled with liquid 354 and sealed 356. The seal 356 may be formed from aluminum, plastic, or another suitable material. The seal 356 keeps the liquid 354 sterile and assures a purchaser of sterility. A puncturing ring 358 is fitted between the seal 356 and the nipple 360. The puncture ring 358 and the nipple 360 are held securely in place by the tightening ring 362. The puncture ring 358 has an elongated finger 364 extending over the seal 356. The finger 364 may be bent downward by pressing on the nipple 360 so as to puncture the seal 356. A small groove 366 is formed at the base of the finger 364 to facilitate bending of the finger 364 downward from the puncture ring 358.

Accordingly, the seal 356 may be broken allowing consumption of the liquid 354 without removal of the nipple 360. This is advantageous because the sterility of the liquid is maintained while breaking the seal 356, and there is no opportunity to spill the liquid while breaking the seal 356.

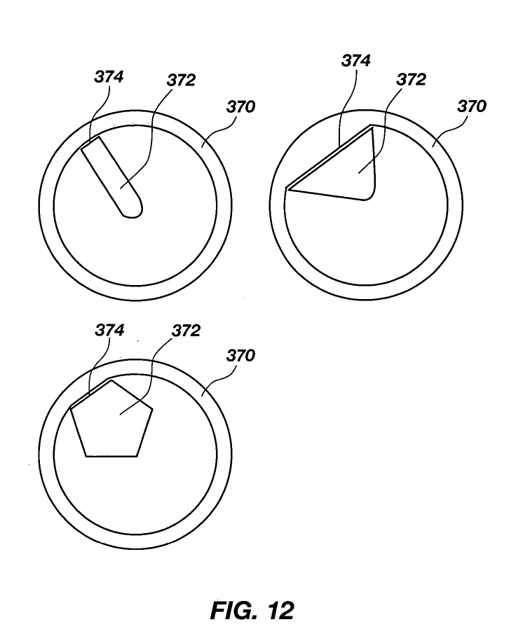

Referring to FIG. 12, a top view of multiple embodiments of the puncture ring 358 is shown. The embodiment includes a continuous outer ring 370. This outer ring 370 allows for a liquid tight seal to be formed between the bottle seal 356 and the nipple 360. Some of the different possible shapes of the elongated finger 372 are shown. This figure also illustrates the use of the groove 374 which facilitates bending of the elongated finger 372 with respect to the ring 370.

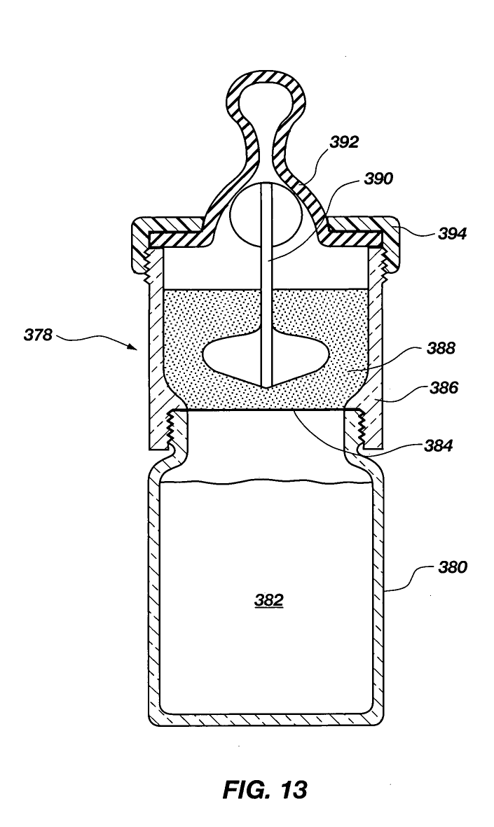

Turning now to FIG. 13, another embodiment of a bottle, indicated generally at 378, is shown. A bottle 380 is pre-filled with a pre-determined amount of sterilized water 382 and sealed 384. The seal 384 may be of aluminum, plastic, or any other suitable material. A collar 386 is attached to the bottle 380 forming a liquid tight seal between the sealed bottle 380 and the collar 386. The collar 386 is then filled with a measured amount of powdered formula 388, enough to mix with the water 382 and make the pre-determined amount of liquid formula.

A plunger 390 is then inserted into the powdered formula 388. The plunger 390 may be formed from a plastic whose density is lighter than water, such as low density poly-ethylene so that the plunger 390 tends to float away from the nipple when an infant is drinking from the bottle 378. Additionally, the top of the plunger 390 is configured so as to allow flow of infant formula through the nipple 392 even if the plunger 390 contacts the nipple 392. A nipple 392 and tightening ring 394 are then tightened over the top of the collar 386, forming a liquid tight seal between the collar 386 and the nipple 392.

The entire contents of the assembled bottle 378 are thus in a sealed and sterilized condition. The bottle 378 can then be heated to the desired temperature and sold. The purchaser pushes down on the nipple 392 causing the plunger 390 to break the seal 384, allowing the liquid 382 and the powdered formula 388 to mix.

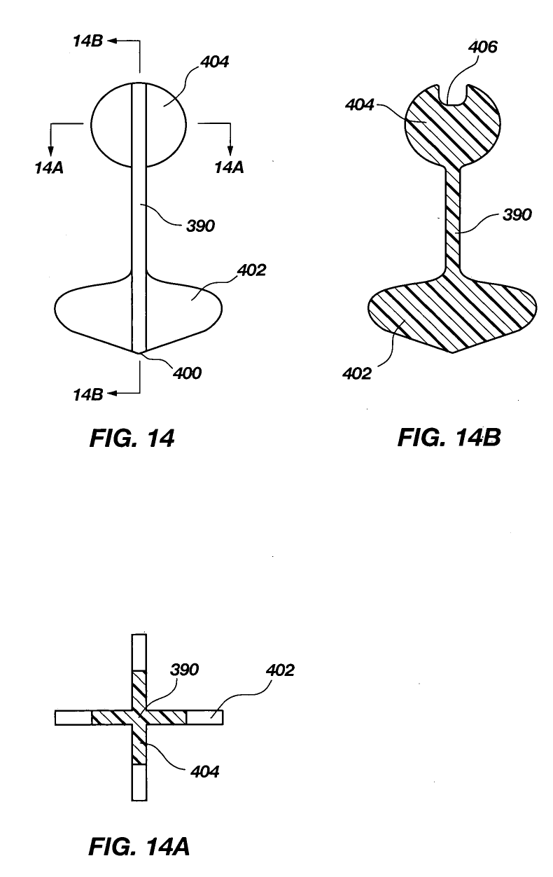

Referring to FIGS. 14 and 14A, the plunger 390 used in the bottle 378 of FIG. 13 is shown in greater detail. The plunger 390 is shown formed with a pointed tip 400 to allow for ease of puncturing the seal 384 of the bottle 378. The bottom of the plunger 390 also is formed with a plurality of vanes 402 which help in puncturing the seal 384. The top of the plunger 390 also is formed with vanes 404 and a recess 406 to allow flow of formula even if the plunger contacts the nipple 392 of the bottle 378 while an infant is drinking from the bottle.

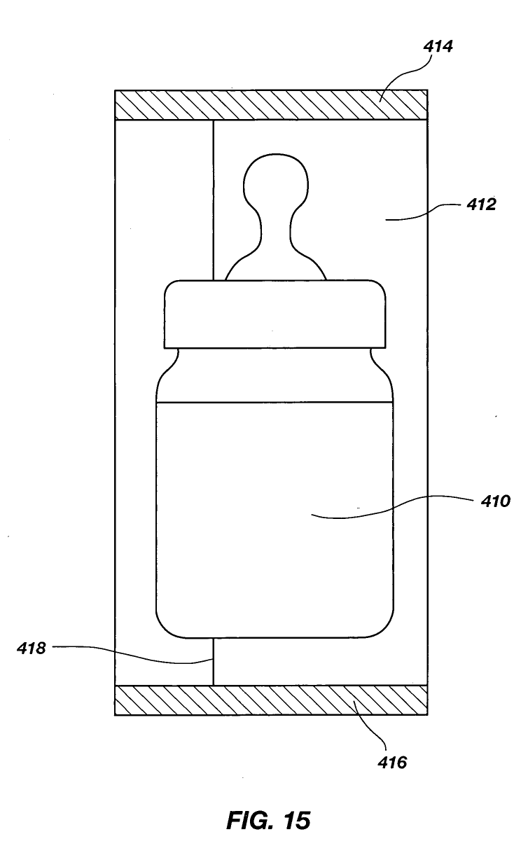

Turning now to FIG. 15, a bottle 410 is shown sealed in a plastic bag 412. It is intended that bottles 410 are pre-filled at a sterile (or substantially sterile) manufacturing facility and sealed in individual bags 412 to assure sterility to the consumer. The bag 412 may contain seals at the top 414, bottom, 416, or side 418. The seals may be formed with an adhesive, by heat sealing, or by any other suitable sealing means, and may be designed to allow for easy opening of the bag 412 by the consumer. Furthermore, the bag 412 may be formed from a plastic material that tears easily, further promoting easy opening by the consumer.

The contents of the bottle 410 may be premixed formula, or water and formula powder maintained separate from one another, a juice concentrate or powder, etc. If the contents are separate, the user can puncture the seal between the two by pressing down on the nipple through the plastic bag, thereby maintaining the cleanliness of the nipple while puncturing the seal.

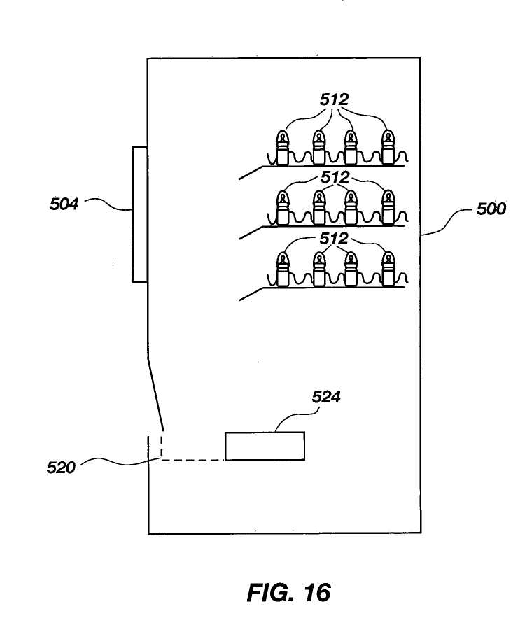

Turning now to FIG. 16, where is shown a cross-sectional view of a vending machine 500. The vending machine 500 includes an interface 504 for activating a dispensing unit 508 to dispense bottles 512. Those skilled in the art will be aware of numerous different dispensing systems which can be used including screw drives, plungers and collapsing shelves.

Also disposed in the vending machine 500 is a warming device 520. The warming device 520 is disposed in the vending machine to heat bottles to a desired temperature—typically 80 to 110 degrees Fahrenheit, and most preferably 90 to 100 degrees Fahrenheit. The warming device 520 can be configured to blow warm air through the vending machine 500, to thereby warm the bottles. In the alternative, the warming device 520 can be configured to receive bottles 512 and warm them. This could be by the use of hot air, microwave radiation, or warm water. Thus, for example, when a user purchases a bottle 512, the bottle may fall into the warming device—i.e. a basket—where it is flooded with hot water for a predetermined period of time. The hot water may then be drawn into the reservoir, where it is reheated and prepared for the next use.

The vending machine 500 allows a parent or other guardian to purchase a warm bottle for an infant at a location regardless of the time of day, or the availability of restaurant personnel and the like. Such a configuration is ideal for such places as airports, where people are often traveling at hours when the restaurants are closed.

Thus there is disclosed an apparatus and method for selling a baby bottle. Those skilled in the art will appreciate numerous modifications which can be made without departing from the scope and spirit of the invention. The appended claims are intended to cover such modifications.

What is claimed is:

1. A method for selling a baby bottle, the method comprising:
selecting a bottle with an infant beverage comprising the group consisting of infant formula and milk, the bottle being sealed to maintain substantial sterility;
warming the bottle in a warming device; and
selling the warmed bottle.

2. The method according to claim 1, wherein the method comprises selling a bottle which is between 80 and 110 degrees.

3. The method according to claim 1, wherein the method comprises warming the bottle to between 90 and 100 degrees.

4. The method according to claim 1, wherein the method comprises selling the bottle while it is still sealed.

5. The method according to claim 1, further comprising removing the seal.

6. A method for dispensing an infant beverage comprising:
selecting a bottle having a liquid and a powder for mixing with the liquid;
warming the bottle while maintaining the liquid and the powder separate; and
selling the bottle.

7. The method according to claim 6, wherein the method comprises mixing the powder and the liquid after warming of the liquid.

8. The method according to claim 6, wherein the method comprises maintaining the liquid in a reservoir portion of the bottle and maintaining the powder in a nipple portion of the bottle prior to mixing.

9. The method according to claim 6, wherein the method comprises maintaining the bottle substantially sterile prior to sale of the bottle.

10. A method of selling infant formula comprising:
selecting a bottle having a seal for keeping a liquid in the bottle sterile;
heating the bottle to a temperature of between 90 and 110 degrees while the bottle is sealed; and
selling the heated, sealed bottle together with a nipple portion.

11. The method according to claim 10, wherein the method comprises puncturing the seal with the nipple portion.

12. The method according to claim 10, further comprising selling the bottle with infant formula.

13. The method according to claim 12, wherein the formula is disposed in the nipple portion.

14. A bottle for selling infant formula, the bottle comprising:
a reservoir portion filled with an infant beverage;
a nipple portion connected to the reservoir portion, the nipple portion being configured for providing access to the infant beverage in the reservoir portion; and
a sealing member disposed about the nipple portion for preventing access to the infant beverage either through nipple portion or by removing the nipple portion from the reservoir portion without breaking the sealing member.

15. A bottle comprising:
a reservoir portion for holding at least a portion of an infant beverage;
a nipple portion attached to the reservoir portion; and
a seal disposed between the nipple portion and the reservoir portion for selectively preventing access to the reservoir portion through the nipple portion.

16. The bottle of claim 15, further comprising a piercing member for opening the sealing member to provide access to the beverage in the reservoir portion.

17. The bottle of claim 16, wherein the nipple portion is compressed or collapsed to open the seal.

18. The bottle of claim 16, wherein the nipple portion is rotated to open the seal.

19. The bottle of claim 16, wherein the nipple portion is slid to open the seal.

20. The bottle according to claim 15, wherein the bottle has a liquid disposed in the reservoir portion and a powder disposed on an opposing side of the seal from the liquid.

21. The bottle according to claim 20, wherein at least a portion of the powder is disposed in the nipple portion.

22. A device for warming a bottle comprising a trough configured for receiving a liquid; a temperature and controls for maintain the liquid at a temperature in excess of 100 degrees Fahrenheit; and a carrier for holding a bottle in the trough and removing the bottle from the trough after a predetermined amount of time.

23. The device according to claim 22, further comprising two troughs for receiving liquids.

24. The device according to claim 23, wherein the two troughs are maintained at different temperatures.

25. The device according to claim 23, further comprising a timer to time the heating of a bottle in a trough.

26. A device for warming a bottle comprising:
a chamber configured for holding warmed air;
a temperature;
controls for maintaining the temperature in the chamber between 80 and 110 degrees; and
at least one bottle disposed within the chamber.

27. The device according to claim 26, comprising at least two chambers.

28. The device according to claim 27, wherein the two chambers are maintained at different temperatures.

29. The device according to claim 27, further comprising a timer to time the heating of the bottles in the chamber.

30. The device according to claim 29, wherein the timer gives a visual or audible signal when the bottle is finished heating.

31. A method for selling infant formula, comprising:
selecting a bottle that is filled with formula and sealed to assure sterility;
selecting a heating unit with two temperature zones;
placing the bottle in one temperature zone to quickly heat the bottle to approximately 90 to 100 degrees;
placing the bottle in the other temperature zone to maintain the bottle at approximately 90 to 100 degrees; and
selling the bottle while the bottle remains sealed.

32. The method according to claim 31, wherein the heating unit temperature zones are controlled to maintain a constant temperature.

33. The method according to claim 31, wherein the heating unit further comprises a timer to time the quick heating of the bottle to approximately 90-100 degrees.

34. A method for dispensing an infant beverage comprising:
selecting a bottle having a liquid and a powder for mixing with the liquid; and
selling the bottle with the liquid and powder isolated from one another.

35. The method according to claim 34, wherein the method comprises selecting a bottle having a seal and a means for puncturing or shearing the seal.

36. The method according to claim 34, wherein the method comprises dispensing the bottle in a plastic bag.

37. An apparatus for dispensing infant formula, the apparatus comprising;
a bottle having infant formula disposed therein and a nipple attached thereto for dispensing the infant formula, and
a seal for covering the nipple and at least a portion of the bottle.

38. The apparatus of claim 37, wherein the seal comprises a plastic bag in which the bottle and nipple are sealed.

39. A method for dispensing of infant formula, the method comprising:
disposing infant formula in a bottle and placing the bottle in a vending machine;
heating the bottle; and
dispensing the bottle to a customer.

40. The method according to claim 39, wherein the method comprises heating the bottle after the bottle is ordered by a user of the vending machine.
